(19) United States
(12) Patent Application Publication
(10) Pub. No.: US 2013/0239237 A1
(43) Pub. Date: Sep. 12, 2013

(54) ESTROUS CYCLE MONITORING BY COLOR RESPONSE

(71) Applicant: ORATEL DIAGNOSTICS, LLC, Hammondsport, NY (US)

(72) Inventor: Dorothee GOLDMAN, Hammondsport, NY (US)

(73) Assignee: ORATEL DIAGNOSTICS, LLC, Hammondsport, NY (US)

(21) Appl. No.: 13/776,015

(22) Filed: Feb. 25, 2013

Related U.S. Application Data
(63) Continuation-in-part of application No. 13/212,864, filed on Aug. 18, 2011, now Pat. No. 8,420,398.
Application No. 13/212,864 is a continuation of application No. PCT/US2011/046586, filed on Aug. 4, 2011.
(60) Provisional application No. 61/375,496, filed on Aug. 20, 2010.
(60) Provisional application No. 61/421,853, filed on Dec. 10, 2010.
(60) Provisional application No. 61/768,042, filed on Feb. 22, 2013.

(51) Int. Cl. G01N 21/78

(52) U.S. Cl. CPC G01N 21/78
USPC 800/8; 436/65; 600/35

(57) ABSTRACT

A method of determining the phase of an estrous cycle that a mammal is in at a given time that a biological sample is obtained from the mammal is provided. The biological sample obtained from the mammal is combined with a flavonol and an anthocyanin and/or iodine on, or which had been stored on and subsequently removed from, a silane-based surface to provide a color response. The estrus phase of the estrous cycle has a corresponding color response that is distinguishable from the color response of each other phase of the estrous cycle to an unaided human eye. The corresponding color response is correlated to the estrus phase of the estrous cycle.

### CROSS REFERENCE TO RELATED APPLICATION(S)

This application is a continuation-in-part of U.S. patent application Ser. No. 13/212,864, filed Aug. 18, 2011, which is a continuation of PCT/US2011/046586 filed Aug. 4, 2011, and claims the benefit of priority of provisional application Nos. 61/375,496 filed Aug. 20, 2010, 61/421,853 filed Dec. 10, 2010, and 61/768,042 filed Feb. 22, 2013. The complete disclosure of U.S. patent application Ser. No. 13/212,864 and U.S. provisional application 61/768,042 are incorporated herein by reference.

### FIELD OF THE INVENTION

This invention relates to the monitoring of an estrous cycle, especially for the detection of the estrus phase of the cycle, preferably using non-invasive test procedures. The invention finds applicability in veterinary, breeding, experimental and other practices.

### BACKGROUND

The successful monitoring of an estrous (also known as oestrous) cycle has many potential uses. For example, artificial insemination of animals, especially cattle and other livestock, as well as other mammals is often employed by dairy farmers and other animal caretakers for breeding. Successful impregnation requires that the artificial insemination procedure take place at the appropriate period within the animal's estrous cycle. Additionally, successful monitoring can allow breeding to be timed to coincide with the appropriate period of an animal's estrous cycle. Such timing may be especially important when, for example, a mare is to be transported to a stallion for breeding. Another example of a potential use for monitoring an estrous cycle is in connection with laboratory testing and studies. Accuracy of certain tests may depend on the administration of a drug or the performance of another procedure during a particular phase of the estrous cycle, or synchronization of testing on test animals so that the administration procedure is performed at the same phase of the subjects' estrous cycles.

The estrous cycle of a female mammal that reabsorbs the endometrium, in contrast to menstruation which releases the endometrium, as occurs in primates, involves recurring hormone-induced physiological changes and generally is characterized by four phases: proestrus, estrus, metestrus, and diestrus. During proestrus, prostaglandin PF2α causes regression of the corpus luteum developed in the previous cycle. As the corpus luteum is destroyed, there is a fall in progesterone levels. The fall in progesterone levels is accompanied by an increase in the production of follicle stimulating hormone (FSH), which stimulates follicular growth in the follicle that will result in ovulation. During this phase there is an increase in circulating estradiol levels.

The estrus phase refers to a periodic state of the estrous cycle in mammals that do not experience menstruation. The estrus phase has two stages. The first stage of the estrus phase is initiated as estradiol levels rise and cause the production of luteinizing hormone (LH). During this first stage of the estrus phase, which is also known as behavioral estrus or “heat,” the estradiol levels will begin to decrease as the LH level surges to a maximum concentration or LH peak. The length of the behavioral expression of estrus (or “heat”) varies from animal to animal. An example of a female mammal with spontaneous ovulation is the cow. Generally, subject to variations between individual animals, behavioral estrus in a cow lasts between 8-36 hours. The subsequent second stage of the estrus phase runs from the LH peak to ovulation. In cows, ovulation may occur approximately 12-18 hours after behavioral estrus or “heat” has ended. During this second stage of the estrus phase, successful inducement of pregnancy is most likely to occur.

Metestrus is a period of sexual inactivity following the estrus phase. Metestrus can last from 1-5 days as observed in the case of cows. In metestrus, early corpus luteum development begins anew in a process known as luteinization and progesterone levels begin to rise. Estradiol levels increase in cyclic phases during metestrus. Metestrus lasts until the beginning of the diestrus phase. During diestrus, estradiol varies in cyclic waves of about 4 days duration and levels of estradiol remain relatively low until proestrus, when the corpus luteum is destroyed through the action of prostaglandins such at PF2α which causes progesterone to fall and estradiol levels to increase to their maximal levels. The cycle thereby repeats itself.

Estrous cycle frequency and duration varies from species to species. Some species of mammals have spontaneous ovulation that comes in regular cycles. The estrous cycles of some species with spontaneous ovulation can also be seasonal. Some mammals have only one “heat” per season, while others may have multiple heats. Other types of mammals have induced ovulation which is stimulated by the presence or contact with a male of the same species. Examples include rabbits, camels, and alpacas.

Failure to timely inseminate during the appropriate phase of the estrous cycle, preferably immediately before (such as within 12 hours of) ovulation, creates a significant economic burden to the farmer. For seasonal breeders, for example, unsuccessful breeding can cause the breeder to wait weeks or months for another breeding opportunity. Further, the insemination and breeding procedures are themselves expensive, and repeating the procedures multiple times on the same animal for a single successful pregnancy can significantly increase costs. Furthermore, the delay inherent in waiting for the next estrus phase or seasonal estrous cycle to re-inseminate the animal compounds the economic burden on the breeder, especially if the animal produces milk, for which maximal production may be dependent on successful breeding and a continuous stream of pregnancies.

About half of all cow estrus phases fail to be observed because the farmer is either not present to actually observe the animal in estrus or because existing estrus detection tests are not sufficiently reliable. P. L. Senger, Estrus Detection Problem New Concepts Technologies and Possibilities, J. Dairy Science, 77:2745-2753 (1994). It has been estimated that failed insemination and breeding costs U.S. dairy farmers over $300 million annually. R. L. Wallace, Economic Efficiencies of Dairy Herd Reproductive Programs, DVM, MS Illinois Dairy Net Papers (Mar. 13, 2002). Hence, accurate and reliable detection of the estrus phase is highly important for high impregnation and breeding success rates and, ultimately, is highly important to farmers and other breeders for economic reasons.

Anthocyanin pigments can be used to measure fertility and estrogen-dependent physiological changes in females. U.S. Pat. Nos. 4,358,288, 5,922,613, and 5,981,291 describe the color response that an anthocyanin pigment produces when contacted with a body fluid such as saliva or vaginal fluid. It has now been observed by the present inventor that certain forms of anthocyanin pigments specified in the aforementioned patents, specifically 3,5-diglycosidyl anthocyanins, show near identical color responses to the unaided eye for both the fertile estrus phase and the mid-luteal phase (i.e., diestrus) of the estrous cycle when tested on a cellulose surface with no other agents. Because the likelihood of successful pregnancy when insemination or breeding in the mid-luteal phase is significantly lower than in the fertile estrus phase, it is desirable for an estrus phase detection test to be capable of distinguishing between these phases.

Commercial kits are available for estrus evaluation of female livestock and other mammals. These known commercial kits at best identify only the general phase of estrus; they do not distinguish between the first stage of the estrus phase (before the LH peak) and second stage of the estrus phase (after the LH peak). The second stage of the estrus phase is the optimal time period for insemination and breeding. Timing insemination or breeding to coincide with the second stage of the estrus phase is important for optimum pregnancy results. Insemination and breeding in the first stage of the estrus phase does not generate pregnancy at nearly the rate of breeding as in the second stage of the estrus phase. Lack of clarity and consistency in known commercial kits results in inaccurate timing for insemination and breeding, causing lower pregnancy rates, increased costs, and decreased efficiency to the breeder.

Accordingly, it is highly desirable to have an estrus detection procedure that allows the inseminator/breeder to determine the estrus phase, and more desirably distinguish the optimal fertile stage of the estrus phase from other phases of the estrous cycle, including the mid-luteal and diestrus phases and desirably the first stage of the estrus phase, in order to efficiently and effectively determine whether the female is (or when the female will be) ready for insemination/breeding.

### SUMMARY OF THE INVENTION

According to a first aspect of the invention, a method is provided of determining the phase of an estrous cycle that a mammal is in at a given time that a biological sample is obtained from the mammal. The biological sample obtained from the mammal is combined with an anthocyanin pigment and flavonol pigment to induce a reaction that provides a color response on a hydrophobic substrate. The estrus phase of the estrous cycle has a corresponding color response to the anthocyanin pigment and the flavonol that is distinguishable to an unaided human eye from the color responses of each other phase of the estrous cycle. The corresponding color response is correlated to the estrus phase of the estrous cycle. In an exemplary embodiment of this first aspect, the anthocyanin pigment has a three-position carbon with a first O-glycosyl group and a five-position carbon with a second O-glycosyl group. In another exemplary embodiment of the first aspect, the color response correlating to a first stage of the estrus phase of the estrous cycle prior to the LH peak is distinguishable to an unaided human eye from the color response correlating to a second stage of the estrus phase of the estrous cycle subsequent to the LH peak.

A second aspect of the invention provides a method of determining the phase of an estrous cycle that a mammal is in at a given time that a biological sample is obtained from the mammal. The biological sample obtained from the mammal is combined with an anthocyanin pigment and divalent metal salt solution to induce a reaction that provides a color response on a hydrophobic substrate. The estrus phase of the estrous cycle has a corresponding color response to the anthocyanin pigment and the divalent metal salt solution that is distinguishable to an unaided human eye from the color responses of each other phase of the estrous cycle. The corresponding color response is correlated to the estrus phase of the estrous cycle. In an exemplary embodiment of this second aspect, the anthocyanin pigment has a three-position carbon with an O-glycosyl group and a five-position carbon without an O-glycosyl group. In another exemplary embodiment of the second aspect, the color response correlating to a first stage of the estrus phase of the estrous cycle prior to the LH peak is distinguishable to an unaided human eye from the color response correlating to a second stage of the estrus phase of the estrous cycle subsequent to the LH peak.

A third aspect of the invention provides a method of determining the phase of an estrous cycle that a mammal is in at a given time that a biological sample is obtained from the mammal. The biological sample obtained from the mammal is combined with a flavonol and iodine to induce a reaction that provides a color response on a hydrophobic substrate. The estrus phase of the estrous cycle has a corresponding color response to the flavonol and the iodine that is distinguishable to an unaided human eye from the color responses of each other phase of the estrous cycle. The corresponding color response is correlated to the estrus phase of the estrous cycle. In an exemplary embodiment of this third aspect, the flavonol is quercetin.

A fourth aspect of the invention provides a method of inducing pregnancy in a mammal which exhibits an estrous cycle. The phase of an estrous cycle that the mammal is in at a given time that a biological sample is obtained from the mammal is monitored by combining the biological sample obtained from the mammal with an anthocyanin pigment and a flavonol pigment to induce a reaction that provides a color response on a hydrophobic substrate. The estrus phase of the estrous cycle has a corresponding color response to the anthocyanin pigment and the flavonol that is distinguishable to an unaided human eye from the color responses of each other phase of the estrous cycle. The mammal is inseminated or bred at a point in time when the mammal is indicated to be in the estrus phase as reflected by the color response. In an exemplary embodiment of this fourth aspect, the anthocyanin pigment has a three-position carbon with a first O-glycosyl group and a five-position carbon with a second O-glycosyl group. In another exemplary embodiment of the fourth aspect, the color response correlating to a first stage of the estrus phase of the estrous cycle prior to the LH peak is distinguishable to an unaided human eye from the color response correlating to a second stage of the estrus phase of the estrous cycle subsequent to the LH peak.

A fifth aspect of the invention provides a method of inducing pregnancy in a mammal which exhibits an estrous cycle. The method involves monitoring the phase of an estrous cycle that the mammal is in at a given time that a biological sample is obtained from the mammal. The monitoring involves combining the biological sample obtained from the mammal with an anthocyanin pigment and divalent metal salt solution to induce a reaction that provides a color response on a hydrophobic substrate. The estrus phase of the estrous cycle has a corresponding color response to the anthocyanin pigment and the divalent metal salt solution that is distinguishable to an unaided human eye from the color responses of each other phase of the estrous cycle. The mammal is inseminated or bred at a point in time when the mammal is indicated to be in the estrus phase as reflected by the color response. In an exemplary embodiment of this fifth aspect, the anthocyanin pigment has a three-position carbon with an O-glycosyl group and a five-position carbon without an O-glycosyl group. In another exemplary embodiment of the fifth aspect, the color response correlating to a first stage of the estrus phase of the estrous cycle prior to the LH peak is distinguishable to an unaided human eye from the color response correlating to a second stage of the estrus phase of the estrous cycle subsequent to the LH peak.

According to a sixth aspect of the invention, a method of inducing pregnancy in a mammal which exhibits an estrous cycle. The method involves monitoring the phase of an estrous cycle that the mammal is in at a given time that a biological sample is obtained from the mammal. The biological sample obtained from the mammal is combined with a flavonol and iodine to induce a reaction that provides a color response on a hydrophobic substrate. The estrus phase of the estrous cycle has a corresponding color response to the flavonol and the iodine that is distinguishable to an unaided human eye from the color responses of each other phase of the estrous cycle. The mammal is inseminated or bred at a point in time when the mammal is indicated to be in the estrus phase as reflected by the color response. In an exemplary embodiment of this sixth aspect, the flavonol is quercetin.

A seventh aspect of the invention provides a method of determining the phase of an estrous cycle that a mammal is in at a given time that a biological sample is obtained from the mammal. The biological sample obtained from the mammal is combined with a flavonol. After being combined with the flavonol, the biological sample is combined with an anthocyanin pigment on or which had been stored on a silane surface to induce a reaction that provides a color response. The estrus phase of the estrous cycle has a corresponding color response to the flavonol and the anthocyanin pigment that is distinguishable to an unaided human eye from the color responses of each other phase of the estrous cycle. The corresponding color response is correlated to the estrus phase of the estrous cycle.

According to an eighth aspect of the invention, a method of inducing pregnancy in a mammal which exhibits an estrous cycle. The method involves determining the phase of an estrous cycle that the mammal is in at a given time that a biological sample is obtained from the mammal. The biological sample obtained from the mammal is combined with a flavonol. After being combined with the flavonol, the biological sample is combined with an anthocyanin pigment on or which had been stored on a silane surface to induce a reaction that provides a color response. The estrus phase of the estrous cycle has a corresponding color response to the flavonol and the anthocyanin pigment that is distinguishable to an unaided human eye from the color responses of each other phase of the estrous cycle. The mammal is inseminated or breed at a point in time when the mammal is indicated to be in the estrus phase as reflected by the corresponding color response.

A ninth aspect of the invention provides a method of determining the phase of an estrous cycle that a mammal is in at a given time that a biological sample is obtained from the mammal. The biological sample obtained from the mammal is combined with a flavonol. After being combined with the flavonol, the biological sample is combined with iodine on or which had been stored on a silane surface to induce a reaction that provides a color response. The estrus phase of the estrous cycle has a corresponding color response to the flavonol and the iodine that is distinguishable to an unaided human eye from the color responses of each other phase of the estrous cycle. The corresponding color response is correlated to the estrus phase of the estrous cycle.

According to a tenth aspect of the invention, a method of inducing pregnancy in a mammal which exhibits an estrous cycle. The method involves determining the phase of an estrous cycle that the mammal is in at a given time that a biological sample is obtained from the mammal. The biological sample obtained from the mammal is combined with a flavonol. After being combined with the flavonol, the biological sample is combined with iodine on or which had been stored on a silane surface to induce a reaction that provides a color response. The estrus phase of the estrous cycle has a corresponding color response to the flavonol and the iodine that is distinguishable to an unaided human eye from the color responses of each other phase of the estrous cycle. The mammal is inseminated or breed at a point in time when the mammal is indicated to be in the estrus phase as reflected by the corresponding color response.

Other aspects of the invention, including apparatus, devices, indicators, kits, processes, and the like which constitute part of the invention, will become more apparent upon reading the following detailed description of the exemplary embodiments.

### BRIEF DESCRIPTION OF THE DRAWING(S)

The patent or application file contains at least one drawing executed in color. Copies of this patent or patent application publication with color drawing(s) will be provided by the Office upon request and payment of the necessary fee.

The accompanying drawings are incorporated in and constitute a part of the specification. The drawings, together with the general description given above and the detailed description of the exemplary embodiments and methods given below, serve to explain the principles of the invention. In such drawings:

FIG. 1 is a chart containing colored photographs showing the relationship between cycle phase and vaginal mucosa color response for an example in which the vaginal mucosa was exposed to an anthocyanin pigment and a flavonol pigment;

FIG. 2 contains colored photographs showing the relationship between cycle phase and saliva color response for an example in which the saliva was treated with an anthocyanin pigment and divalent metal salt solution;

FIG. 3 contains colored photographs showing the relationship between cycle phase and cow saliva color response for an example in which the cow saliva was treated with a flavonol pigment and iodine;

FIG. 4 contains colored photographs showing the relationship between cycle phase and horse saliva color response for an example in which the horse saliva was treated with a flavonol pigment and iodine;

FIG. 5 contains colored photographs showing the relationship between cycle phrase and horse saliva color response for an example in which the horse saliva was treated with an anthocyanin pigment and a flavonol pigment;

FIG. 6 shows color response results of examples performed in accordance with an exemplary embodiment;

FIG. 7 is a schematic of a kit for carrying out methods described herein; and

FIG. 8 is a schematic of another kit for carrying out methods described herein.

### DETAILED DESCRIPTION OF THE EXEMPLARY EMBODIMENTS AND EXEMPLARY METHODS

Reference will now be made in detail to exemplary embodiments and methods of the invention. It should be noted, however, that the invention in its broader aspects is not necessarily limited to the specific details, representative materials and methods, and illustrative examples shown and described in connection with the exemplary embodiments and methods.

Estrus detection as described herein may be used with various types of mammalian animals having estrous cycles, including for example cows, horses, swine, sheep, goats, laboratory animals such as rats, mice, and hamsters. It should be noted that exemplary embodiments of the invention are not applicable to saliva collected from guinea pigs because their saliva lacks the characteristic proline rich proteins that are sensitive to this assay. Because successful impregnation or breeding is most probable if it occurs during the second stage of the estrus phase, i.e., subsequent to the LH peak, it is desirable that the detection allow the tester to distinguish the first stage of the estrus phase (prior to the LH peak) from the second stage of the estrus phase in order to optimize insemination and breeding success rates.

The disciplines of estrous cycle monitoring and estrus phase detection are also useful in fields other than pregnancy inducement and mapping of different phases of the estrous cycle. For example, in carrying out laboratory experiments on animals such as mice, dogs, rats, etc., the particular estrous cycle phase of a laboratory animal is often an unknown variable that can influence the results of tests performed on the animal. By predetermining which phase of an estrous cycle a laboratory animal is in at the time of testing, the technician can schedule the substantive tests on the lab animals while each is in the same predetermined/preselected estrous cycle phase to thereby isolate this cycle-phase variable and thus prevent it from contributing to the variability of the test results.

The distinctive color responses corresponding to each phase of the estrous cycle also allows a farmer/breeder/caretaker to monitor for whether an animal is not cycling or has anestrous cycles. The breeder, for example, may take samples periodically (e.g., daily) and observe for color patterns relating to hormonal activity. Mammals that are not cycling generally will not display the above-described color patterns. An anestrous female will not demonstrate color change (i.e., the same continuous color response) over a time frame equivalent to an estrous cycle of that female species. Non-cycling and anestrous cycles may reflect nutritional deficiencies in the diet of the animal that require attention.

The selected biological sample preferably yet optionally is a non-invasive specimen that is attainable from the subject without requiring penetration of the skin, such as with a needle or scalpel as part of a surgical procedure. Preferably vaginal fluid or saliva is the non-invasive biological sample. Various biological samples, such as fluids (e.g., blood, vaginal fluid) and non-fluids (e.g., skin, etc.) may be selected. Saliva may be collected using known procedures, for example, by introducing an absorbent material such as a sponge into the mouth of the animal for a sufficient time to allow the sponge to absorb the saliva. The saliva collected from the subject is then extracted from the sponge, for example, by inserting the sponge into a device (e.g., syringe having a plunger) that can press the saliva into a collection vessel, such as an Eppendorfer tube. Alternatively, a portion or the entire estrus indicator may be directly inserted into and contacted with the inside of the animal's mouth or vagina to collect the biological sample.

### First Embodiment

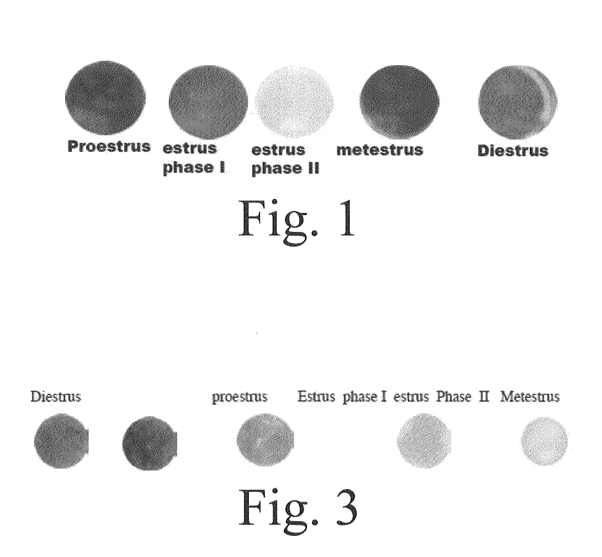

In a first exemplary method a female mammal is monitored for the estrus phase of the female mammal's estrous cycle. The exemplary method features depositing a biological sample from the female mammal on a hydrophobic substrate during a phase of the estrous cycle, and contacting the biological sample with an anthocyanin pigment and a flavonol pigment to produce a color response indicative of the phase of the estrous cycle of the female mammal at the time the biological sample was collected. The color responses (see, e.g., FIG. 1) produced by the different phases of the estrous cycle are visually distinctive from one another to the unaided human eye. However, it should be understood that even though differences in color responses are observable to the unaided human eye, analyzing equipment such as colorimeters and spectrophotometers, while not generally necessary for carrying out this embodiment, optionally may be employed to distinguish between estrous cycle phases.

An exemplary substrate on which the biological sample is deposited for this first exemplary embodiment has a hydrophobic surface. Suitable substrate materials include polyethylene, glass, starch, and plastics such as styrene, polypropylene, or cyclo-olefins. Where the substrate is not hydrophobic, it may be modified or treated with a wetting agent (e.g., a surfactant or detergent) or covered with a hydrophobic surface layer. See, e.g., U.S. Pat. No. 4,125,673. For example, suitable substrates may be prepared by coating a base with a layer of 2% Methocel A (Dow chemical). Exemplary substrates are glass, polyethylene, Porex X-4901, Porex X-4903, Porex X-4905, Porex X-6410, Porex A-8480 (Porex Technologies) and similar pads having a porosity of about 50 microns or greater. Glass and like substrates may be treated with one or more silane compounds, for example, n-butyltrimethoxysilane and 3-aminopropyltrimethoxysilane, to stabilize the pigments. Transparent silane compounds also allow the biological samples to be viewed there through for monitoring color response. Transparent silane compounds are especially useful with transparent substrates such as glass. The assay can be performed on the silane on one side/end of the substrate, and the color response can be viewed (through the substrate and silane) from the opposite side/end of the substrate.

The hydrophobic substrate is inoculated with a flavonol. An exemplary flavonol suitable for this and other exemplary embodiments of the invention is quercetin.

For example, according to one exemplary procedure, 1×10⁻⁵ to 1×10⁻³ molar concentration of quercetin is dissolved in ethanol mixed in a ratio by volume of 80:20, for ethanol mixed with a buffer at pH>8. 100 microliters of this solution is added to the hydrophobic substrate and allowed to dry at ambient conditions. The test sample is inoculated onto the hydrophobic surface that has been treated with the flavonol. The resulting color is yellow. In order read a color response that is unique to a particular phase of the estrous cycle, the assay is exposed to an anthocyanin pigment. In this and other embodiments using a flavonol such as quercetin and an anthocyanin, the concentrations of quercetin and anthocyanins may be equal or substantially equal to one another.

Generally, anthocyanin pigments useful for this first embodiment may possess the following structure:

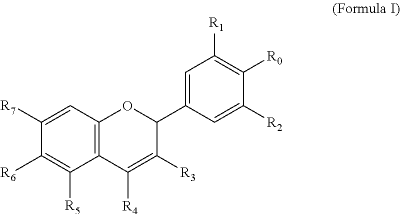

wherein R₀ may be selected from the group consisting of hydrogen and hydroxy, but preferably is hydroxy; R₁ may be selected from the group consisting of hydrogen, hydroxy, and C₁-C₄ alkoxy such as methoxy; R₂ may be selected from the group consisting of hydrogen, hydroxy, and C₁-C₄ alkoxy such as methoxy; R₃ (appended to the three-position carbon) and R₅ (appended to the five-position carbon) each is an O-glycosyl group, wherein R₃ and R₅ may be the same or different relative to one another; R₄ is preferably hydrogen; R₆ may be selected from the group consisting of hydroxy and hydrogen; and R₇ is selected from the group consisting of hydrogen, hydroxy, and C₁-C₄ alkoxy, but preferably is a hydroxy group.

Using these pigments, the visible color response produced by the estrus phase of the estrous cycle is distinctive from the other phases. Hence, the visible color response permits the determination of the corresponding phase of the estrous cycle of the female mammal. Representative exemplary anthocyanins pigments of this first exemplary embodiment include cyanidin 3,5-diglucoside, petunidin-3,5-diglucoside, hirsutidin 3,5-diglucoside, pelargonidin 3,5-diglucoside, malvidin 3,5-diglucoside, and petunidin 3,5-diglucoside. These and other anthocyanins and other flavonoids described herein may be obtained from various commercial sources, such as, for example, Sigma Aldrich and Polyphenols in Norway. Alternative sources are also available. The anthocyanin is dissolved in methanol at 1×10⁻⁵ to 1×10⁻³ molar concentration. Other alcohol solutions having molar concentrations of, for example, 10⁻¹ M to 5×10⁻⁴ M are exemplary. Alternatively, the solution may be dried before it is deposited on the substrate.

As described above, pigments other than malvidin 3,5-diglucoside may be used in accordance with exemplary embodiments described herein. The particular color response pattern over the course of the estrous cycle may vary from one pigment to another. That is, the specific synchrony between proestrus, estrus, metestrus, and diestrus and their corresponding color responses for malvidin 3,5-diglucoside is not necessarily shared by other useful pigments. The matching of corresponding color response patterns to other anthocyanin-biological sample combinations may be determined, for example, by tracking color responses of the combinations relative to ovulation of the animal.

The color response reveals the phase of the estrous cycle of the mammal as of the time the sample was obtained, and allows the breeder or inseminator to determine when the estrus phase will occur. If the color response dictates that the animal is currently in the estrus phase, insemination may proceed or may be slightly delayed to correspond to the optimum time for insemination, i.e., after the LH peak. On the other hand, if the color response dictates that the animal is in proestrus, metestrus, or diestrus, a timetable for the animal's estrous cycle may be used to predict when estrus and ovulation may be expected. Optionally, testing can be repeated on a periodic (e.g., daily) basis up to the second stage of the estrus phase and/or ovulation to ensure that insemination or breeding is timely synchronized with the cycle.

### Second Embodiment

According to a second exemplary embodiment, the biological sample obtained from the mammal is combined with an anthocyanin pigment and divalent metal salt solution (e.g., aqueous calcium chloride or zinc chloride) to induce a reaction that provides a color response on a hydrophobic substrate. The hydrophobic surface may be any of those described above in connection with the first embodiment. An exemplary anthocyanin pigment for this second embodiment is one having the structure of Formula I above, but in which the three-position carbon has an O-glycosyl group and the five-position carbon preferably does not have an O-glycosyl group. The five-position carbon substituent may be, for example, hydrogen, hydroxy, or alkoxy, such as methoxy.

The hydrophobic surface is treated with the metallic salt solution, preferably prior to exposure to the biological sample, particularly when the pigment selected has a three-position carbon with an O-glycosyl group and a five-position carbon with no O-glycosyl group. Saliva typically has a salt concentration between 1×10⁻³M and 1×10⁻⁴M. Salt concentration present in body fluid such as saliva will vary depending upon the time of day and flow rate when the saliva sample is collected. To eliminate natural fluctuations in the natural salt concentration as a variable in the testing procedure, the salt concentration of the saliva is optionally artificially raised above 1×10⁻² M, such as into a range of about 1×10⁻¹ M to about 5×10⁻² M. Divalent metal salt solutions are particularly useful for this purpose.

It has been found that divalent salts such as calcium chloride, zinc chloride, zinc gluconate, and magnesium salts such as magnesium chloride yield conditions that allow the estrus phase to produce color responses that are visually distinct from the other phases of the estrous cycle. It has even been found that the color responses may uniquely correspond to each phase of the estrous cycle when the biological sample is exposed to the anthocyanin pigment with an 3-O-glycoside, no 5-O-glycoside, and a position 7-hydroxyl group, thus allowing for a distinct color response to represent each phase of the estrous cycle, and both stages of the estrus phase: one color for diestrus, one color for proestrus, one color for the first stage of the estrus phase prior to the LH peak, one color for the second stage of the estrus phase subsequent to the LH peak, and one color for metestrus, with each of the colors being visually distinguishable from one another, preferably to the unaided human eye. Calcium chloride (1×10⁻² molar) has been found to be a particularly exemplary divalent metal salt solution, especially when the selected anthocyanin pigment is malvidin 3-glucoside.

In exemplary embodiments of the invention in which an anthocyanin is used, the anthocyanin pigment may be dissolved in an alcohol, such as methanol. Other forms of alcohol such as ethanol and isopropanol and other solvents may also be used. The anthocyanin pigment may be deposited as part of a solution, e.g., with the pigment dissolved in alcohol, or dispersed in a non-solvent. Alcohol solutions having molar concentrations of, for example, 10⁻¹ M to 5×10⁻⁴ M are exemplary. Alternatively, the solution may be dried before it is deposited on the substrate.

For example, a hydrophobic substrate such as Porex X-6410 or Porex X-8480 may be contacted with 20 microliters of 2% methyl cellulose mixed with a defined concentration of a divalent salt and allowed to dry at room temperature. This treated substrate is then stamped to form small discs that are placed in respective wells formed in the top of the titer plate. The titer plate containing the treated substrate discs in its wells can be stored in ambient conditions until the plate is ready for use. Optionally, the well may be pre-inoculated with the anthocyanin pigment in methanol, for example, with a concentration of 1×10⁻³ M, and allowed to dry in ambient conditions. The biological sample such as saliva from a female mammal is deposited in the wells of the hydrophobic substrate and optionally dried and analyzed (or stored for later analysis). Exposure of the deposited biological sample to the pigment generates a color response that may be recorded. It should be understood that alternative sequences of processing steps may be practiced. For example, the divalent metal salt may be applied to the substrate before or after the biological sample is applied. Likewise the pigment may be deposited into the well before the biological sample is applied, or the pigment may be inoculated onto the hydrophobic substrate after the biological sample has been applied.

In this and other exemplary embodiments, the color response generally becomes discernible within 15 minutes after exposing the saliva or other biological sample to the pigment or combination of pigments. Depending upon the pigment, the color responses of the different cycle phases may be sufficiently distinctive that a person may observe and visually distinguish between the different color responses with the unaided human eye. However, it should be understood that analyzing equipment such as colorimeters and spectrophotometers, while not generally necessary, optionally may be employed.

Carrying out an example of the second exemplary embodiment in which malvidin-3-glucoside is selected as the anthocyanin and in which the substrate is pre-treated with dilute concentrations of calcium chloride or zinc chloride solution, distinct color responses are observed for each phase of the estrous cycle and in both stages of the estrus phase. These distinct color responses observed in cow saliva include: a blue-purple color response is produced during diestrus, a pale white color response is indicative of proestrus, a dark or aqua blue response is produced in the first stage of the estrus phase, a pale blue response is produced in the second stage of the estrus phase, and a pink response is indicative of a saliva sample obtained at the end of metestrus. As demonstrated by this example, distinguishable color responses does not necessarily mean different colors, but may mean different yet distinguishable shades of a color, such as in the case of the dark blue response of the first stage of the estrus phase and the pale blue response of the second stage of the estrus phase.

Without wishing to be bound by any theory, it is believed that these distinct color responses arise due to variations in mucin composition and structure. It is known that gylcosylation of mucins is altered during the estrous cycle. Braga Vania M. M. and Sandra J. Gendler, Modulation of Muc-1 Mucin Expression in the Mouse Uterus During Estrus, Early Pregnancy, and Placentation, Journal of Cell Sciences. Vol. 105, pp. 397-405 (1993). It is also known that estradiol affects membrane transport of salt in the biological sample which changes according to each phase of the estrous cycle. T. R. Ediger, W. L. Kraus, E. J. Weinman, and B. S. Katzenellenbogen, Estrogen Receptor Regulation of the Na+/H+ Exchanger Regulatory Factor, Endocrinology, Vol. 140, No. 7, pp. 2976-82 (1999). Changes in sodium and chlorine ions also affect the hydrophobic and hydrophilic properties of the mucins. Marie Skepo, Per Linse, and Thomas Arnebrant, Coarse-Grained Modeling of Proline Rich Proteinl (PRP-1) in Bulk Solution and Adsorbed to a Negatively Charge Surface, J. Phys. Chem. B., 110 (24) pp. 12141-12148 (2006). The structural changes in the mucins brought about by both degylcosylation and changes in salt concentration affect whether or not certain anthocyanins will either form intensely colored stacked complexes or remain uncomplexed ionic forms that give color responses reflective of their aqueous equilibrium state. P. Mazzaracchio, P. Pifferi, M. Kindt, A. Munyaneza, and G. Barbiroli, Interactions between Anthocyanins and Organic Food Molecules in Model Systems, International Journal of Food Science and Technology, Vol. 39, Issue 1, pp. 53-59 (2004).

The purple response of diestrus is generated by equilibrium between different forms of the anhydrobase forms of the anthocyanin. In proestrus, increased levels of estradiol results in enzyme production that removes certain sugar groups on the mucins, thus rendering these mucins hydrophobic and vulnerable to “aggregation” which results in the changes as to how anthocyanins respond to water, thereby causing degradation of any colored anthocyanin complexes. Saliva during the estrus phase shows no “aggregation” of mucins thus allowing for anthocyanins to form complexes that interact through “stacking” in association with a divalent metallic ion. This pigment “stacking” in the presence of a divalent ion allows for a stable dark blue response during the first stage of the estrus phase. As discussed in further detail below, as estrus progresses, the stacking interaction of the anthocyanin is reduced, which is reflected in appearance as a fading of the blue color response. Contacting the biological sample to a defined concentration of divalent metallic salt in the presence of the anthocyanin pigment further assists the breeder to distinguish the estrus phase from the diestrus and proestrus phase, and thereby facilitates more accurate prediction of when the estrus phase will occur.

For example, if the color response dictates that the animal is currently in the estrus phase, insemination or breeding may proceed or may be slightly delayed to correspond to the optimum time for insemination or breeding, i.e., after the LH peak. On the other hand, if the color response dictates that the animal is in proestrus, metestrus, or diestrus, a timetable for the animal's estrous cycle may be used to predict when the estrus phase and ovulation may be expected. Optionally, testing can be repeated on a periodic (e.g., daily) basis up to the second stage of the estrus phase and/or ovulation to ensure that insemination or breeding is timely synchronized with the cycle.

In the context of this second embodiment, anthocyanins having a three-position carbon with an O-glycosyl group and a five-position carbon with no O-glycosyl group are particularly effective in producing visible color responses for the first and second stages of the estrus phase, i.e., prior and subsequent to the LH peak, respectively, that are visually distinctive of one another to the unaided human eye. For example, using malvidin 3-glucoside, a deep blue color response is indicative of the first stage of the estrus phase (prior to the LH peak). The second stage of the estrus phase becomes visually discernible when the deep blue begins to fade to a pale blue. The second stage of the estrus phase up to approximately the onset of ovulation (including the beginning of ovulation) is the ideal time to inseminate a cow with demonstrated effectiveness. Thus, when the color response transitions from deep or dark blue to pale blue, the animal should be inseminated or bred immediately or soon thereafter, for example, within approximate 12 hours from obtaining the biological sample providing the pale blue response, and preferably within approximately 18 hours from then. The white color indicative of proestrus informs the breeder that estrus is possible in, for example, 24-36 hours after the biological sample has been collected so that the breeder may follow up with another test within that time frame. Pale blue informs the breeder that ovulation is imminent and now is the best time to inseminate. Pink is the color observed in metestrus and indicates that ovulation is occurring. Release of blood in the vagina is a sign that confirms that ovulation has occurred.

As described above, pigments other than malvidin 3-glucoside may be used in accordance with exemplary embodiments described herein. The particular color response pattern over the course of the estrous cycle may vary from one pigment to another. That is, the specific synchrony between proestrus, estrus, metestrus, and diestrus and their corresponding color responses of white, blue, pink, and purple for malvidin 3-glucoside are not necessarily shared by other useful pigments. The matching of color response patterns to other anthocyanin-biological sample combinations may be determined, for example, tracking color responses of the combinations relative to ovulation of the animal.

### Third Embodiment

According to other exemplary embodiments, a flavonol may be selected as the pigment. Flavonols have a chemical structure similar to the anthocyanin structure described above, except that R₄ is a keto group and R₃ is usually a hydroxyl group (i.e., 3-hydroxyflavone).

Hydrophobic substrates and other testing procedures and parameters discussed above with respect to the first and second embodiments may be implemented in this third embodiment. For example, the flavonol pigment may be dissolved in an alcohol such as ethanol. Generally, the use of mono- and divalent metals is less important in this third embodiment in which a flavonol is used with iodine. The biological sample may be processed as described above in connection with the first and second embodiments.

As explained above, in accordance with exemplary methods the anthocyanins, flavonols, and other flavonoids produce a color response in synchrony with the different phases of the estrous cycle. Selection of quercetin followed by exposure to iodine resulted in a blue color response for diestrus, a golden brown color response for proestrus, and a clear color response for estrus, and yellow for metestrus.

### Fourth Embodiment

The fourth embodiment follows the same general protocol as described above with respect to the description of the first embodiment, which is incorporated herein by reference, with the following additions and alterations. In the fourth embodiment, the biological sample obtained from the mammal is combined with a flavonol on a first surface. After being combined with the flavonol, the biological sample is combined with, for example contacted to, an anthocyanin pigment on (or that had been stored on and subsequently removed from) a silane-treated second surface to induce a reaction that provides a color response. Techniques described above with respect to earlier embodiments may be used to place and optionally dry the quercetin on the silane-treated surface. The estrus phase of the estrous cycle has a corresponding color response to the flavonol and the anthocyanin pigment that is distinguishable to an unaided human eye from the color responses of each other phase of the estrous cycle. The corresponding color response is correlated to the estrus phase of the estrous cycle.

The first and second surfaces may be the same or different from one another. The first surface treated with the flavonol (e.g., quercetin) may be made of an absorbent and/or permeable material. Filters such as Porex X-8489, Porex X-9477, Porex X-8480, and other filters mentioned herein may be used. The flavonol-treated filter may also be treated with a dilute anti-oxidizer, such as 5 percent by weight ascorbic acid, to prevent oxidation of the flavonol (e.g., quercetin). The anti-oxidant may be premixed with the flavonol (e.g., quercetin) or applied directly to the filter prior to or after application of the flavonol.

The second surface (for the anthocyanin pigment) is pre-treated with one or more silane compounds, especially organic silane compounds, to form a film or membrane on the second surface. The second surface may be made of a non-hydrophobic material with the hydrophobic organic silane film/membrane applied to the surface. Exemplary organic silane compounds include n-butyltrimethoxysilane (CAS#1067-57-8) and 3-aminopropyltrimethoxysilane (CAS#13822-56-5). Silane modification of surfaces is described in, for example, Silane Modification of Renewable Resources, 1990 Nonwovens Conference, pp. 253-255; and Gelest, Inc., An Organosilane Chemistry Primer, pp. 16-17; Phase News, Vol. 1, No. 1. Commercial silane compounds suitable for use with the present invention are available through Gelest, Inc. The silane compounds may be applied to the surfaces as a solution, such as a 5-10 percent by volume solution in toluene. The first surface also may be treated with the same or a different silane compound, especially an organic silane compound such as n-butyltrimethoxysilane or 3-aminopropyltrimethoxysilane. Silane compounds such as n-butyltrimethoxysilane and 3-aminopropyltrimethoxysilane stabilize the pigments, thereby allowing the pigments to be stored (e.g., impregnated or coating) on their surfaces for prolonged periods of time (e.g., several months) prior to use. Further, the silane compounds enhance color resolution and are transparent to permit visual inspection of the color response there through. Thiol (mercaptan) silane compounds have less of a stabilizing effect and therefore are less preferred.

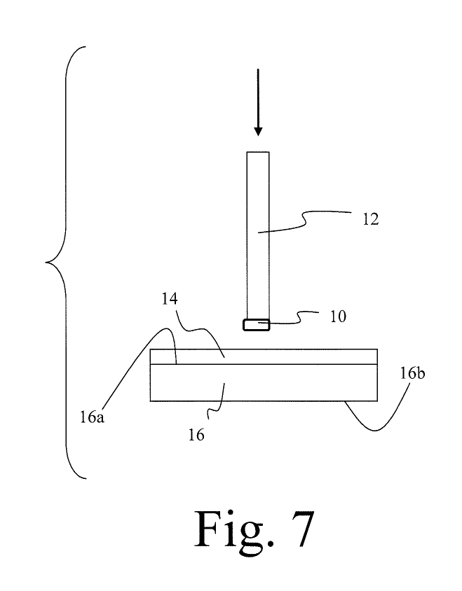

According to an exemplary implementation of this fourth embodiment shown in FIG. 7, a specimen collection device, for example a collection material 10 such as a Porex filter supported on a holder 12 such as a straw, is contacted with the mammalian subject, such as the vaginal mucosa of the subject, or with an already collected biological sample of the subject. The contact is firm and sufficiently long enough to transfer the biological sample to the collection material 10. Typically, one to a few seconds will suffice. The collection material 10 may be absorbent to retain fluid biological samples. As shown by the arrow in FIG. 7, the collection material 10 having the biological sample is pressed onto the upper (or first) surface of a first substrate 14 that has been pretreated with a flavonol, such as quercetin. The lower surface of the first substrate 14 is in contact with an upper surface 16a of a second substrate 16. The upper (or second) surface 16a of a second substrate 16 is pretreated with a silane compound and an anthocyanin. As described above, the silane compound improves the stability of the anthocyanin and may improve the ability to read the resulting color response. As shown in FIG. 7, the upper surface 16a of the second substrate 16 is predisposed in contact with the lower surface of the first substrate 14. The upper substrate 14, which may be a filter, is sufficiently porous or permeable to allow the biological sample to transfer to (and hence combine with) the anthocyanin on the upper surface 16a of the second substrate 16. It is especially useful if the second substrate 16 is glass or another transparent material. The color response on the upper surface 16a of the second substrate 16 may be viewed from below a downward facing lower surface 16b of the second substrate 16. Various modifications can be made to this implementation. For example, the pretreated upper surface 16a of the second substrate 16 may be brought into contact with the first substrate 14 after the biological sample has been transferred to the first substrate 14. As another alternative, the collection material 10 may be predisposed in contact with the first substrate 14 when the biological sample is collected.

According to another modification of the implementation shown in FIG. 7, the first surface containing the flavonol (e.g., quercetin) forms part of the collection device that is brought into contact with the mammal. In other words, with reference to FIG. 7, the collection material 10 may be eliminated, and the first substrate 14 pretreated with quercetin or another flavonol is brought into contact with the mammal to collect the biological sample. The second substrate 16 may be glass or another transparent material having its upper surface coated with the silane compound and pretreated with an anthocyanin. The second substrate 16 may be predisposed in contact with the first substrate 14 when the biological sample is collected or, in the alternative, may be brought into contact with the first substrate 14 after the biological sample has been collected on the first substrate.

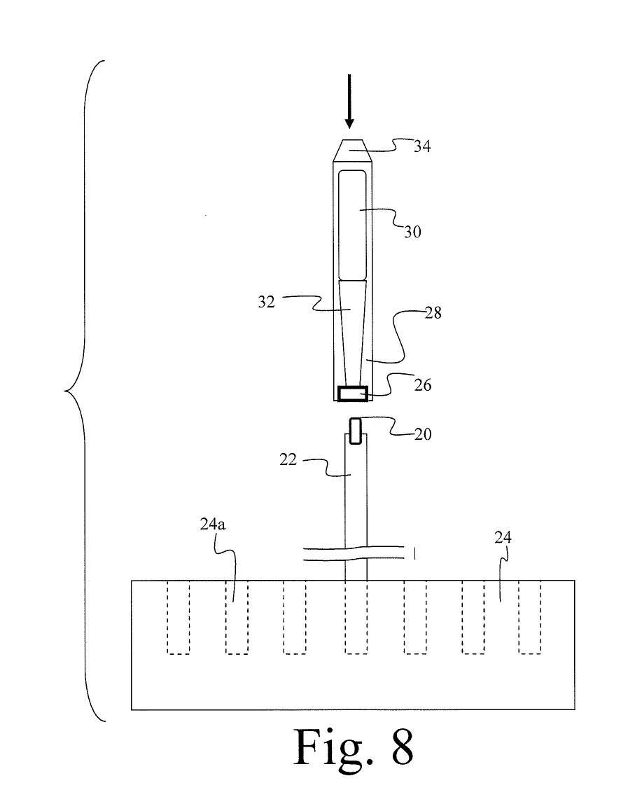

According to another implementation of this fourth embodiment shown in FIG. 8. In this implementation, anthocyanin stored on a silane-treated surface is removed from the silane-treated surface and combined with the biological sample and flavonol. A first substrate 20 such as a Porex filter pre-treated with quercetin or another flavonol is contacted with the mammal or a collected biological sample of the mammal to transfer the biological sample to the quercetin-treated first substrate 20. The first substrate 20 is shown retained at the end of a collection device 22, such as a straw. The opposite end of the collection device 22 may be set into one of the openings 24a of a holder 24 so that the collection device 22 is supported vertically by the holder 24 with the exposed first substrate 20 facing upward. A second substrate 26 made of a permeable material such as a Porex filter is pretreated with silane, and impregnated or otherwise treated with an anthocyanin. The second substrate 26 is retained at the lower end of a housing 28 such as a second straw. The housing 28 includes a sponge 30 and a pipette tip extending between the lower end of the sponge 30 and the upper surface of the second substrate 26. The sponge is saturated with an alcohol. A removable cap 24 is at the upper end of the housing 28. In practice, the collection device 22 having the first substrate 20 is exposed to the mammal or its already collected biological sample to transfer the biological sample to the first substrate 20. For example, the first substrate 20 may be brought into contact with the upper labia of the vagina of a mammal. The lower end of the collection device 22 is placed in one of the openings of the holder 24 to secure the exposed first substrate 20 in place. The top cap 34 of the housing 28 is removed an inverted to protrude into the top opening of the straw 22. The cap 34 is pressed downward (as shown by the arrow in FIG. 8), such as with the thumb of the user, to compress the sponge 30 and cause the alcohol in the sponge 30 to flow downward through the pipette tip 32 onto the second substrate 20 pretreated with the silane and the anthocyanin. As the alcohol washes through the second substrate 26 onto the exposed first substrate 20, the anthocyanin stored on the second substrate 26 is transferred to the first substrate 20 to react with the biological sample on the quercetin-treated first substrate 20 and thereby induce a color response.

According to a modification of the implementation shown in FIG. 8, a separate collection device such as a Porex filter is used to collect the biological sample from the subject, such as the vaginal mucosa of the subject. The biological sample is transferred from the collection device to the quercetin-treated first substrate 20. The collection device may be similar to the collection device (10 and 12) shown in FIG. 7. As another modification, the collection device may be predisposed in contact with the quercetin-treated first substrate 20 at the time the biological sample is collected or otherwise transferred to the collection device. As still another modification, the collection device may be brought into contact with the first substrate 20 after the biological sample has been collected or otherwise transferred to the collection device.

### Fifth Embodiment

The fifth embodiment follows the same general protocol as described above with respect to the description of the third embodiment, which is incorporated herein by reference, with the following additions and alterations. In the fifth embodiment, the biological sample obtained from the mammal is combined with a flavonol on a first substrate. After being combined with the flavonol, the biological sample is combined with, for example contacted to, iodine on a second substrate to induce a reaction that provides a color response. The estrus phase of the estrous cycle has a corresponding color response to the flavonol and the iodine that is distinguishable to an unaided human eye from the color responses of each other phase of the estrous cycle. The corresponding color response is correlated to the estrus phase of the estrous. cycle.

The implementations discussed above in connection with the fourth embodiment may be followed in carrying out the fifth embodiment, except that iodine is substituted for the anthocyanin.

In the above embodiments, the particular color responses each occur at a specific corresponding phase in the estrous cycle and thereby allow for accurate prediction as to when would be the best time for insemination or breeding of the subject animal from which the biological sample was obtained. In the event that the color response corresponds to the fertile late estrus phase of the cycle, artificial insemination may be carried out immediately. Where the test results indicate that the animal is in another phase of the estrous cycle, the result may be used to estimate how many days or hours are needed to reach late estrus for optimal insemination results. The accurate prediction of the estrus phase and ovulation can be used for any of the purposes discussed herein, e.g., to optimize efficiency of natural or artificial insemination and ultimately save the breeder (e.g., farmer, caretaker, etc.) time and money. Further, the testing procedure can be conducted without the expertise of a professional laboratory technician or specialized lab facilities, allowing for faster result turn-around times and thereby reducing missed opportunities for successful insemination.

The following saliva collection procedures are suitable for carrying out the examples. It should be understood that other procedures may be practiced in carrying out any embodiment or example described herein. The saliva samples are obtained on a daily basis using a sponge. The sponge may be wetted, such as by rinsing it in about 1 ml distilled water one or more times. The sponge is inserted into a cow's mouth and held (and optionally moved) inside the mouth for a sufficient amount of time to absorb a saliva specimen, e.g., about 20-40 seconds. After being removed from the subject's mouth, the sponge may be inserted into a syringe. The plunger of the syringe is pushed to extract the saliva from the sponge into a suitable tube or other collection vessel. The sponge may then be discarded. The vessel may be appropriately marked, e.g., identification indicia, date, and time of collection. Generally, a sponge may yield about 3 ml of saliva. Optionally within several hours of collecting the saliva in a sponge, the sponge may be stored in a refrigerator for several hours. It is preferred not to store the sponge below freezing temperature. After the saliva has been extracted from the sponge, however, the saliva may be frozen until ready for testing. The system may be vacuum sealed in a plastic package or other packaging to preserve its shelf life. Alternatively, ascorbic acid can be added to the filter to serve as an antioxidant and preserve shelf life. According to an implementation, the ascorbic acid may be applied to the filter and dried before the flavonol (e.g., quercetin) is applied.

The following examples are provided for purposes of explanation and elaboration, and are not exhaustive of the scope of the exemplary embodiments described herein.

### EXAMPLES

### Example 1

### Embodiment 1

### Anthocyanin/Flavonol

The surface of a polyethylene substrate was treated with 20 microliters of 2 weight percent A4C Methocel (Dow Chemical). Then 50 microliters of 1×10⁻⁵ molar quercetin dissolved in ethanol/pH 8 buffer (80 vol %:20 vol %) combination was added. The surface of the treated substrate was inoculated with 50 microliters of cow saliva as obtained from inside the mouth of a cow. The assay was treated with 20 microliters of 1×10⁻³ molar concentration of the pigment malvidin 3,5-diglycoside and the color response was recorded. The results are shown in FIG. 1 and set forth below in Table 1.

TABLE 1

| Cycle Phase | Color Response |
|---|---|
| Diestrus | Purple |
| Proestrus | Green |
| Estrus | Stage 1: pale green |
| | Stage 2: yellow/Clear |
| Metestrus | Blue |
| | Pink (at end of Metestrus Phase) |

In Example 1, the pale green and yellow/clear color responses of the first and second stages of the estrus phase or visually distinguishable to an unaided human eye from the purple, green, and blue/pink color responses of diestrus, proestrus, and metestrus, respectively. Further, the pale green response of the first stage of the estrus phase is visually distinguishable from the yellow/clear response of the second stage of the estrus phase.

### Example 2

### Embodiment 2

### Anthocyanin/Divalent Metal Salt Solution

The surface of a polyethylene substrate was treated with 20 microliters of 2 weight percent A4C Methocel (Dow Chemical). Then, 20 microliters of 1×10⁻¹ (0.1) molar calcium chloride was applied to the undersurface of the treated substrate, and the substrate was dried. The upper surface of the treated substrate was inoculated with several microliters of saliva absorbed from the side of the mouth of a cow. The assay was treated with 20 microliters of 1×10⁻³ molar concentration of the pigment malvidin 3-glycoside and the color response was recorded. The results are set forth below.

TABLE 2

| | | | | | Lutein- |
|---|---|---|---|---|---|
| | | | | | izing |
| | | | Proges- | Estro- | hormone |
| Cycle | | | terone | gen | (LH) level |
| phase | Time | Color Response | (ng/mg) | (ng/mg) | (ng/mg) |
| Proestrus | Day 3 | Purple | <4 | >0.004 | >2 |
| | Day −2 | Pale Purple | <2 | | |
| | Day −1 | No color/white | <2 | 0.01 | 4 |
| Estrus | Day 0 | Deep blue 1^{st} | <2 | <0.002 | >10 |
| | | stage | | | |
| | 8-30 hours | Pale blue 2^{nd} | | | |
| | | stage | | | |
| Ovulation | 10-14 hrs | Pink | <2 | <0.002 | <2 |
| Metestrus | 3-4 days | Pink-purple | 4 | >4 | <2 |
| Diestrus | 12-15 days | Blue-purple | >4 | 0.002 | <2 |

For example, a purple color response for cow saliva tested with malvidin 3-glucoside indicates not to inseminate the mammal. Pale white or no visible color indicates that the estrus phase is possibly within 24-36 hours. Deep blue indicates that the cow is in the estrus phase and insemination should be performed when the dark blue fades to pale within the next approximately 12-18 hours to coincide with ovulation. Pale blue indicates that ovulation is imminent and insemination should be performed immediately. A pinkish purple color indicates metestrus meaning that ovulation has occurred. The deep blue color response corresponding to the estrus phase is visually distinguishable to the unaided human eye from the corresponding color responses of the other phrases of the estrous cycle. Likewise, the deep blue and pale blue color responses corresponding to the first and second stages of the estrus phase are visually distinguishable from one another.

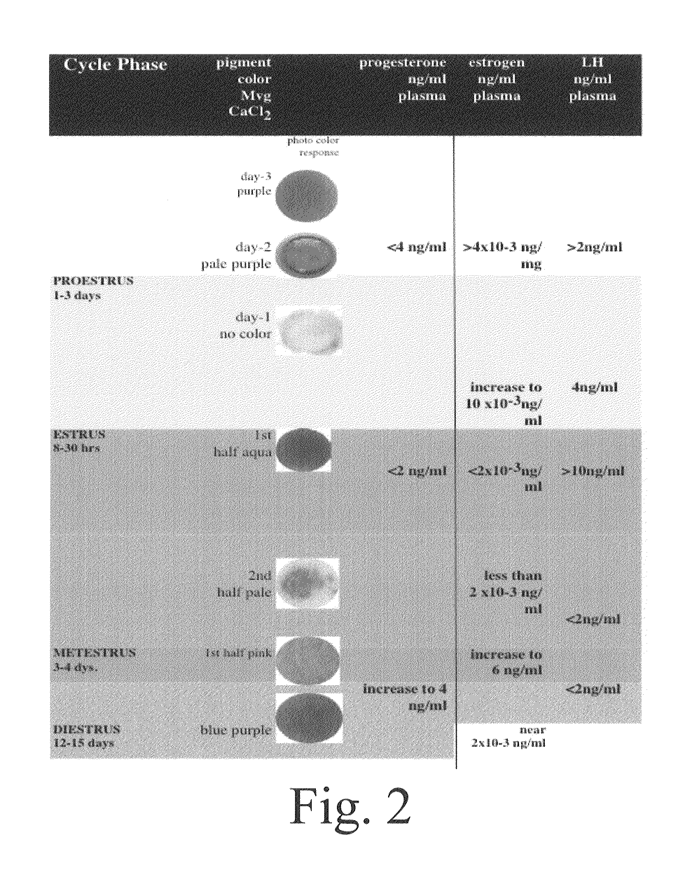

Colored photographs of the responses obtain from Example 2 are shown in FIG. 2.

### Example #3

### Embodiment 3

### Flavonol/Iodine

The surface of Porex X-4904 filter was inoculated with 1×10⁻³ molar quercetin and allowed to dry in ambient conditions. 50 microliters of saliva from a cow were pipetted onto the surface of the treated Porex. Next, 20 microliters of 10% tincture of iodine was pipetted onto the exposed Porex surface, and the color responses were recorded as follows:

TABLE 3

| Cycle Phase | Color Response |
|---|---|
| Diestrus | Blue-brown |
| Late Diestrus | Dark blue-brown |
| Proestrus | Green |
| Estrus | Clear |
| Metestrus | Yellow |

The color responses reported in Table 3 are shown in FIG. 3.

### Example 4

The procedures of Example 3 were repeated with horse saliva. The results are shown in FIG. 4.

### Example 5

### Hypothetical Corresponding to Embodiment 1

A titer plate is treated with a defined concentration of malvidin 3,5-diglucoside dissolved in methanol. A sheet of Porex filter is soaked in 1×10⁻⁵ molar quercetin and allowed to dry. Circular pieces of the Porex filter are punched out of the sheet and placed in respective wells of the titer plate. 20 microliters of 2% methocel is added to the Porex Filter. 40-50 microliter saliva samples are obtained from cows in different phases of their estrous cycles in accordance with the procedures described above. The saliva samples are added to respective wells. 50 microliters 1×10⁻³ molar of anthocyanin pigment with 3,5-diglycosides dissolved in methanol is added. Alternatively, the anthocyanin pigment can be put onto a surface and allowed to dry. When the test sample is wet, it is contacted to the surface that has the anthocyanin pigment. After 15 minutes of exposure to the saliva, a color response was observed for each well. The saliva sample from the cow in early proestrus will produce a green color response. The saliva sample from the cow in diestrus will produce a purple color response. The saliva sample from the cow in the estrus phase will produce a pale green or yellow color response, depending upon whether the sample was taken before or after the LH peak. The saliva sample corresponding to the metestrus phase will produce a blue or pink response.

### Example 6

### Corresponding to Embodiment 1

Malvidin 3,5-digluoside (Poly Phenols) was mixed with methanol to prepare a 1×10⁻³ molar solution. Quercetin (Sigma Aldrich) was weighed and mixed with ethanol and diluted in sodium hydroxide to prepare a 1×10⁻³ molar solution. Porex X-4901 was cut into a strip and coated with methocel 4AC (2%, Dow Chemical). After drying, the strip was soaked in the 1×10⁻³ molar quercetin.

A saliva sample was absorbed from the mouth of a mouse using a “Q-tip.” The wetted Q-tip was pushed own on the surface of the Porex filter, and absorption of the saliva sample onto the filter was noted by observation of a deepening of the yellow color of the quercetin on the filter. 1 microliter of 1×10⁻³ malvidin 3,5-diglucoside was exposed to the wet spot of the filter. The saliva sample from the estrus phase produced a green color response that was visually distinguishable from the mostly purple color responses corresponding to the other phases of the estrous cycle.

### Example 7

### Corresponding to Embodiment 1

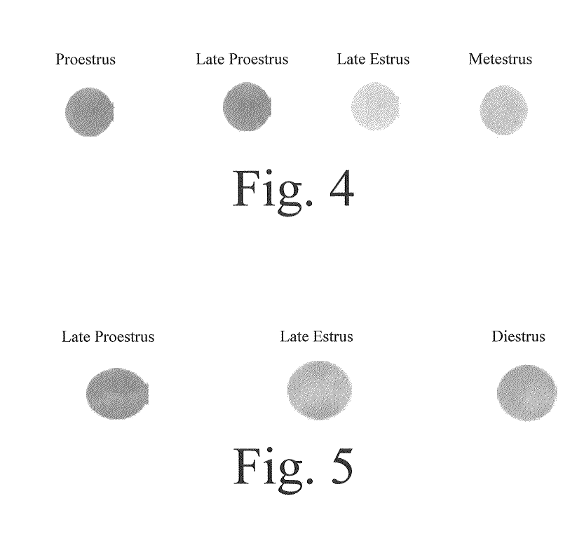

Saliva was collected from horses by inserting clean wet sponges into a horse's mouth. The sponge was removed and placed into a plunger which pushed the saliva into a 2 ml Eppendorfer tube. 20 microliters of the sample were pipetted onto the surface of a Porex X-6410 filter that had been treated with 20 microliters of 1×10⁻³ molar quercetin (dissolved in ethanol and buffer at pH=8 at 90:10 ratio). After 15 seconds, 20 microliters of 1×10⁻³ molar malvidin 3,5-diglucoside was pipetted onto the Porex filter treated with the saliva and quercetin. The recorded color responses were aqua green for late proestrus, blue-gray for second stage of the estrus phase, and faded purple for diestrus. The results are shown in FIG. 5.

### Example 8

### Corresponding to Embodiment 4

To prepare the substrates, glass slides were cleaned with acetone (laboratory grade) and then rinsed in isopropyl alcohol for 30 minutes. The materials were dried in an oven at 140° C. for 10-20 minutes. The prepared glass slides were then soaked in a solution of 5% by volume silane/toluene for 1 hour. After the one hour, the slides were cleaned with toluene in a beaker, then allowed to dry on a glass plate in an oven at 140° C.-150° C. for 5-10 minutes. The first substrates were prepared by coating a first set of the silane-treated glass slides with 1×10⁻³ molar solution of quercetin prepared in ethanol, then drying in ambient conditions. The second substrates were prepared by coating a second set of the silane-treated glass slides with 1×10⁻³ molar solution of malvidin 3,5-diglucoside prepared in methanol and then drying in ambient conditions.

A high speed filter membrane of polyethylene material such as Porex or Merocel was used to absorb a sample of the mucosa from the vagina of a cow. The high speed filter membrane was held in fine contact with the upper central area of the vaginal labia of a cow for 2-3 seconds so that a vaginal mucosa sample was absorbed onto the high speed filter membrane. A first fiber glass filter (Millipore) pretreated with 5% n-butyltrimethoxysilane and coated with 1×10⁻³ molar quercetin (Sigma Aldrich) as described above was placed against the high speed filter membrane to absorb the vaginal mucosal sample, thereby providing contact between the quercetin and the biological sample. The composition on the first fiber glass filter was then contacted with a second fiber glass filter (Millipore) pretreated with 5% n-butyltrimethoxysilane and coated with 1×10⁻³ molar malvidin 3,5-diclucoside (Polyphenols).

### Example 9

20 microliters of 1×10⁻³ molar quercetin in ethanol was pipette onto the surface of a Porex filter (X-8480). The quercetin-treated Porex filter was contacted to the mucosa on the upper part of the interior labia of the vagina of a test subject (cow). 20 microliters of 1×10⁻³ molar anthocyanin in methanol was pipette onto the surface of the exposed quercetin-treated Porex filter. Photographs were taken of color responses, and responses were recorded on a data sheet.

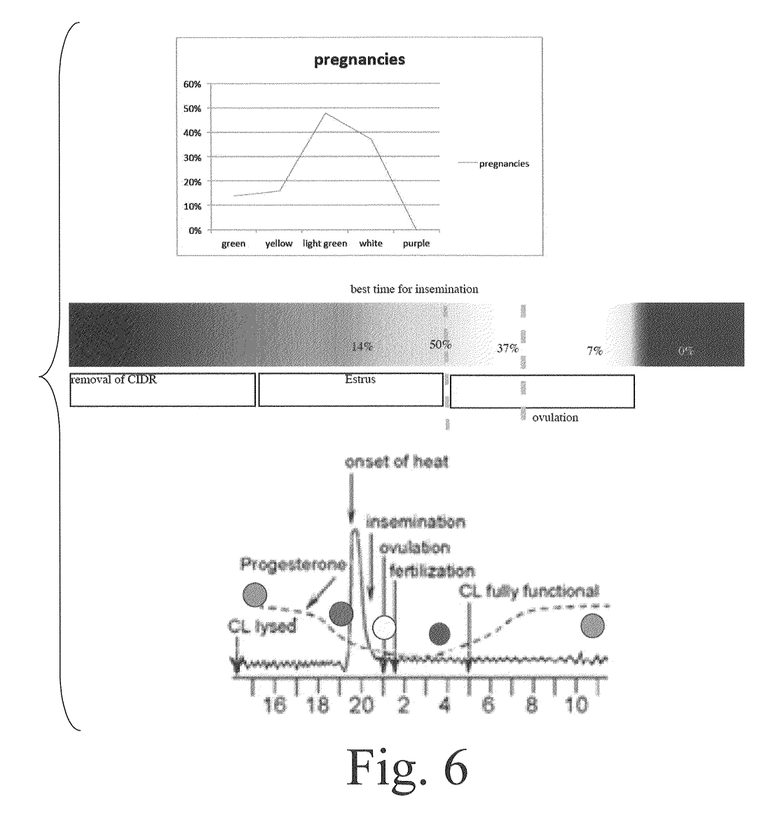

The color response and pregnancy results of Example 9 are reported in the Table 4 below and shown in FIG. 6. Pregnancies were verified by ultrasound examination by a veterinarian.

TABLE 4

| Color response | Total Cows | Pregnancies | Percentage |
|---|---|---|---|
| Yellow | 6 | 1 | 16% |
| White | 38 | 14 | 38% |
| Light green | 21 | 10 | 48% |
| Green | 6 | 1 | 16% |
| Purple | 7 | 0 | 0% |

### Example 10

Tincture of iodine is diluted with isopropyl alcohol to provide a 10 percent solution. A silane-treated fiberglass filter (Millipore) in the shape of a disc is soaked in the iodine solution for a second. The wet disc is placed under a quercetin-treated filter (Porex). The biological sample may be saliva, vaginal fluid, or skin pressed against or into the quercetin-treated filter. The wetted material is exposed to the iodine and a color response is observed on the surface of the quercetin-treated filter. Biological samples that are not in estrus of from a female about to ovulate will show a blue color response. Biological samples from a female mammal that is about to ovulate will show a yellow response.

### Example 11

Fiberglass filters were cleaned with acetone (laboratory grade) then rinsed in isopropyl alcohol for 30 minutes. The fiberglass filters were then dried in an oven at 140° C. for 10-20 minutes. The fiberglass filters were then soaked in a solution of 5 percent by volume silane in toluene for 1 hour, after which the filters were cleaned with toluene in a beaker. Then, the fiberglass filters were allowed to dry on a glass plate in an oven at 140° C.-150° C. for 5-10 minutes.

First fiberglass filters (micropore) were prepared by coating a first set of silane-treated fiberglass filters with 1×10⁻³ molar solution of quercetin in ethanol, then drying in ambient conditions. Second fiberglass filters (micropore) were prepared by coating a second set of the silane-treated glass slides with 1×10⁻³ molar solution of malvidin 3,5-diglucoside prepared in methanol and then drying in ambient conditions. The first fiberglass filters that had been soaked with quercetin were placed on top of the second fiberglass filters than had been soaked with malvidin 3,5-diglucoside. The layered filters were laid on cleaned glass slides (not silane treated), so that the second filters treated with malvidin 3,5-dilgycoside were adjacent the glass slide. The glass slide was covered with a water-resistant wrapper with instructions printed on it for conducting the assay. The wrapper included an opening/cut-out to allow the quercetin-treated filter to be exposed to the biological sample and viewed.

The skin of the inner labia of the vagina of a cow was cleaned with a paper towel, then a test strip of the quercetin-treated fiberglass was pressed against the inner part of the upper labia of the vagina so that the quercetin-treated fiberglass was exposed to the labia skin. By pressing hard against the glass at the bottom of the assay, the malvidin 3,5-diglucoside of the second fiberglass filter was transferred to the quercetin-treated first filter, causing a color response. A blue purpose color response indicated diestrus, and a light or pale yellow color response indicated stage 2 of the estrus phase.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. The specification describes specific examples to accomplish a more general goal that may be accomplished in another way.

Only those claims which use the words “means for” are to be interpreted under 35 U.S.C. 112, sixth paragraph. Moreover, no limitations from the specification are to be read into any claims, unless those limitations are expressly included in the claims.

What is claimed is:

1. A method of determining the phase of an estrous cycle that a mammal is in at a given time that a biological sample is obtained from the mammal, comprising combining the biological sample obtained from the mammal with a flavonol and subsequently combining the biological sample with an anthocyanin pigment on, or which had been stored on and subsequently removed from, a silane surface to induce a reaction that provides a color response, the estrus phase of the estrous cycle having a corresponding color response to the flavonol and the anthocyanin pigment that is distinguishable to an unaided human eye from the color responses of each other phase of the estrous cycle, and correlating the corresponding color response to the estrus phase of the estrous cycle.

2. The method of claim 1, wherein each phase of the estrous cycle has a corresponding color response that is distinguishable to the unaided human eye from the color responses of each other phase of the estrous cycle.

3. The method of claim 1, wherein the anthocyanin pigment has a three-position carbon with a first O-glycosyl group and a five-position carbon with a second O-glycosyl group.

4. The method of claim 3, wherein the anthocyanin pigment comprises a member selected from the group consisting of cyanidin 3,5-diglycoside, petunidin 3,5-diglycoside, hirsutidin 3,5-diglycoside, pelargonidin 3,5-diglycoside, and malvidin 3,5-diglycoside.

5. The method of claim 3, wherein the anthocyanin pigment comprises malvidin 3,5-diglycoside.

6. The method of claim 3, wherein the color response correlating to a first stage of the estrus phase of the estrous cycle prior to the LH peak and the color response correlating to a second stage of the estrus phase of the estrous cycle subsequent to the LH peak are visually distinctive from one another to the unaided human eye.

7. The method of claim 1, wherein the flavonol pigment comprises quercetin.

8. The method of claim 1, wherein the biological sample comprises a vaginal sample.

9. The method of claim 1, wherein the silane comprises a member selected from the group consisting of n-butyltrimethoxysilane and 4-aminopropyltrimethoxysilane.

10. The method of claim 1, wherein the silane surface comprises a silane layer coated on a substrate.

11. The method of claim 1, wherein the reaction is induced on the silane surface containing the anthocyanin.

12. The method of claim 1, wherein:
the anthocyanin pigment has a three-position carbon with a first O-glycosyl group and a five-position carbon with a second O-glycosyl group; and
the flavonol comprises quercetin.

13. The method of claim 12, wherein the anthocyanin pigment comprises a member selected from the group consisting of cyanidin 3,5-diglycoside, petunidin 3,5-diglycoside, hirsutidin 3,5-diglycoside, pelargonidin 3,5-diglycoside, and malvidin 3,5-diglycoside.

14. The method of claim 13, wherein the anthocyanin pigment comprises malvidin 3,5-diglycoside.

15. A method of inducing pregnancy in a mammal which exhibits an estrous cycle, comprising:
determining according to the method of claim 1 the phase of an estrous cycle that the mammal is in at a given time that a biological sample is obtained from the mammal; and
inseminating or breeding the mammal at a point in time when the mammal is indicated to be in the estrus phase as reflected by the corresponding color response.

16. A method of determining the phase of an estrous cycle that a mammal is in at a given time that a biological sample is obtained from the mammal, comprising combining the biological sample obtained from the mammal with a flavonol and subsequently combining the biological sample with iodine on, or which had been stored on and subsequently removed from, a silane surface to induce a reaction that provides a color response on a hydrophobic substrate, the estrus phase of the estrous cycle having a corresponding color response to the flavonol and the iodine that is distinguishable to an unaided human eye from the color responses of each other phase of the estrous cycle, and correlating the corresponding color response to the estrus phase of the estrous cycle.

17. The method of claim 16, wherein each phase of the estrous cycle has a corresponding color response that is distinguishable to the unaided human eye from the color responses of each other phase of the estrous cycle.

18. The method of claim 16, wherein the anthocyanin pigment has a three-position carbon with a first O-glycosyl group and a five-position carbon with a second O-glycosyl group.

19. The method of claim 18, wherein the anthocyanin pigment comprises a member selected from the group consisting of cyanidin 3,5-diglycoside, petunidin 3,5-diglycoside, hirsutidin 3,5-diglycoside, pelargonidin 3,5-diglycoside, and malvidin 3,5-diglycoside.

20. The method of claim 18, wherein the anthocyanin pigment comprises malvidin 3,5-diglycoside.

21. The method of claim 18, wherein the color response correlating to a first stage of the estrus phase of the estrous cycle prior to the LH peak and the color response correlating to a second stage of the estrus phase of the estrous cycle subsequent to the LH peak are visually distinctive from one another to the unaided human eye.

22. The method of claim 16, wherein the flavonol comprises quercetin.

23. The method of claim 16, wherein the biological sample comprises a vaginal sample.

24. The method of claim 16, wherein the silane comprises a member selected from the group consisting of n-butyltrimethoxysilane and 4-aminopropyltrimethoxysilane.

25. The method of claim 16, wherein the silane surface comprises a silane layer coated on a substrate.

26. The method of claim 16, wherein the reaction is induced on the silane surface containing the anthocyanin.

27. The method of claim 16, wherein:
the anthocyanin pigment has a three-position carbon with a first O-glycosyl group and a five-position carbon with a second O-glycosyl group; and
the flavonol comprises quercetin.

28. The method of claim 27, wherein the anthocyanin pigment comprises a member selected from the group consisting of cyanidin 3,5-diglycoside, petunidin 3,5-diglycoside, hirsutidin 3,5-diglycoside, pelargonidin 3,5-diglycoside, and malvidin 3,5-diglycoside.

29. The method of claim 28, wherein the anthocyanin pigment comprises malvidin 3,5-diglycoside.

30. A method of inducing pregnancy in a mammal which exhibits an estrous cycle, comprising:
determining according to the method of claim 16 the phase of an estrous cycle that the mammal is in at a given time that a biological sample is obtained from the mammal; and
inseminating or breeding the mammal at a point in time when the mammal is indicated to be in the estrus phase as reflected by the color response.

31. A method of determining the phase of an estrous cycle that a mammal is in at a given time that a biological sample is obtained from the mammal, comprising combining the biological sample obtained from the mammal with a flavonol and subsequently combining the biological sample with a member selected from the group consisting of an anthocyanin pigment and iodine on, or which had been stored on and subsequently removed from, a silane surface to induce a reaction that provides a color response, the estrus phase of the estrous cycle having a corresponding color response to the flavonol and the member that is distinguishable to an unaided human eye from the color responses of each other phase of the estrous cycle, and correlating the corresponding color response to the estrus phase of the estrous cycle.
